(19) United States
(12) Patent Application Publication
(10) Pub. No.: US 2010/0231380 A1
(43) Pub. Date: Sep. 16, 2010

(54) MULTIFUNCTIONAL PORTABLE ELECTRONIC DEVICE HAVING AN INTEGRATED SMOKE ALARM FEATURE AND ALARMING METHOD THEREOF

(75) Inventor: HSIAO-CHUN LIU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/557,692

(22) Filed: Sep. 11, 2009

(30) Foreign Application Priority Data
Mar. 13, 2009 (CN) 200910300863.X

(51) Int. Cl. G08B 1/08

(52) U.S. Cl. 340/539.13; 340/628

(57) ABSTRACT

A multifunctional portable electronic device includes a smoke sensing device, a controlling module, a positioning module, an alarm module; and a wireless transmitting/receiving module electrically connected together. The smoke sensing device senses the smoke concentration in the air. The controlling module determines whether the smoke concentration exceeds a preset smoke concentration threshold; and when the smoke concentration exceeds a preset smoke concentration threshold, the controlling module controls the positioning module to identify the position of the portable electronic device. The alarm module converts the position information to alarming information, and the alarming information is sent to a preset object via the wireless transmitting/receiving module.

### CROSS-REFERENCE TO RELATED APPLICATIONS

This application is related to a co-pending U.S. patent application Ser. No. (Attorney Docket No.: US23576), entitled “MULTIFUNCTIONAL PORTABLE ELECTRONIC DEVICE AND METHOD FOR USING THE SAME”, by SHENG-HSIUNG YANG This application has the same assignee as the present application. The above-identified application is incorporated herein by reference.

### BACKGROUND

1. Technical Field

The present disclosure generally relates to portable electronic devices, particularly to a multifunctional portable electronic device having an integrated smoke alarm feature and alarming method thereof.

2. Description of Related Art

Usually, smoke detectors are installed in a building to sense the smoke concentration in the air to find fires. However, smoke detectors installed in a building can only sense the smoke concentration in the nearby air, and has a low sensitivity. On the other hand, it is burdensome for people to carry a smoke sensor with them. Furthermore, a conventional smoke sensing device may only sense the smoke, but cannot signal for help in time.

Therefore, there is room for improvement within the art.

### BRIEF DESCRIPTION OF THE DRAWINGS

Many aspects of the multifunctional portable electronic device having an integrated smoke alarm feature and the alarming method thereof can be better understood with reference to the following drawings. The components in the drawings are not necessarily drawn to scale, the emphasis instead being placed upon clearly illustrating the principles of the multifunctional portable electronic device having an integrated smoke alarm feature and the alarming method thereof.

FIG. 1 shows a block diagram of a multifunctional portable electronic device with an exemplary embodiment.

FIG. 2 shows a flow chart of an alarming process of the multifunctional portable electronic device shown in FIG. 1.

### DETAILED DESCRIPTION

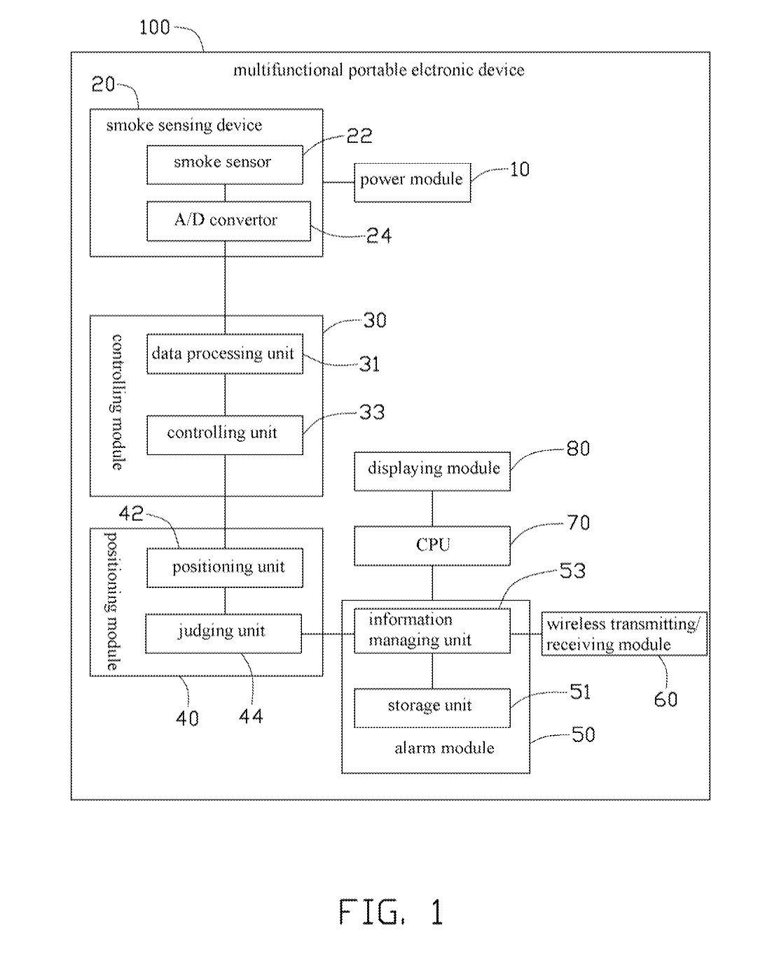

Referring to FIG. 1, a multifunctional portable electronic device 100 includes a power module 10, a smoke sensing device 20, a controlling module 30, a positioning module 40, an alarm module 50, a wireless transmitting/receiving module 60, a central processing unit (CPU) 70, and a displaying module 80. The power module 10, the smoke sensing device 20, the controlling module 30, the positioning module 40, the alarm module 50, and the wireless transmitting/receiving module 60 are electrically connected in series. The alarm module 50 is also connected to the displaying module 80 via the CPU 70.

The power module 10 supplies power to the smoke sensing device 20, the controlling module 30, the positioning module 40, the alarm module 50, the wireless transmitting/receiving module 60, the CPU 70, and the display module 80.

The smoke sensing device 20 includes a smoke sensor 22 and an analog/digital (A/D) convertor 24 electrically connected with the smoke sensor 22. The smoke sensor 22 senses the current smoke concentration in the ambient environment of the portable electronic device 100 and obtains an analog signal of the smoke concentration. The A/D convertor 24 receives the analog signal of the smoke concentration value from the smoke sensor 22, and converts the analog signal of the smoke concentration value to digital signal.

The controlling module 30 includes a data processing unit 31 and a controlling unit 33 electrically connected to the data processing unit 31. The data processing unit 31 is electrically connected to the A/D convertor 24 to receive the digital signal of the smoke concentration value from the A/D convertor 24. Furthermore, the data processing unit 31 stores a predetermined smoke concentration threshold. The data processing unit 31 determines whether the current smoke concentration value exceeds the predetermined smoke concentration threshold and sends a smoke level result to the controlling unit 33. The controlling unit 33 sends an alarm signal to the positioning module 40 if the smoke concentration value exceeds the predetermined smoke concentration threshold.

The positioning module 40 includes a positioning unit 42, and a judging unit 44 electrically connected to the positioning unit 42. The positioning unit 42 may be a module in a global position system (GPS) capable of identifying the position of the portable electronic device 100. The positioning unit 42 is used to obtain a current position of the portable electronic device 100 after receiving the controlling signal from the controlling unit 33. The judging unit 44 is used to determine whether the positioning unit 42 obtained the position of device 100 and if so, sends the position to the alarm module 50.

The alarm module 50 includes a storage unit 51 and an information managing unit 53 electrically connected. The storage unit 51 preset an object therein such as a local emergency telephone number. The information managing unit 53 is connected to the positioning module 40 to receive position information, converts the position information to alarm information, and sends the alarming information to the wireless transmitting/receiving module 60 and the CPU 70.

The wireless transmitting/receiving module 60 receives the alarming information from the information managing unit 53, and then sends the alarming information to the object preset in the storage unit 51. The CPU 70 processes the alarming information for the displaying module 80 to display. The displaying module 80 displays the processed alarming information.

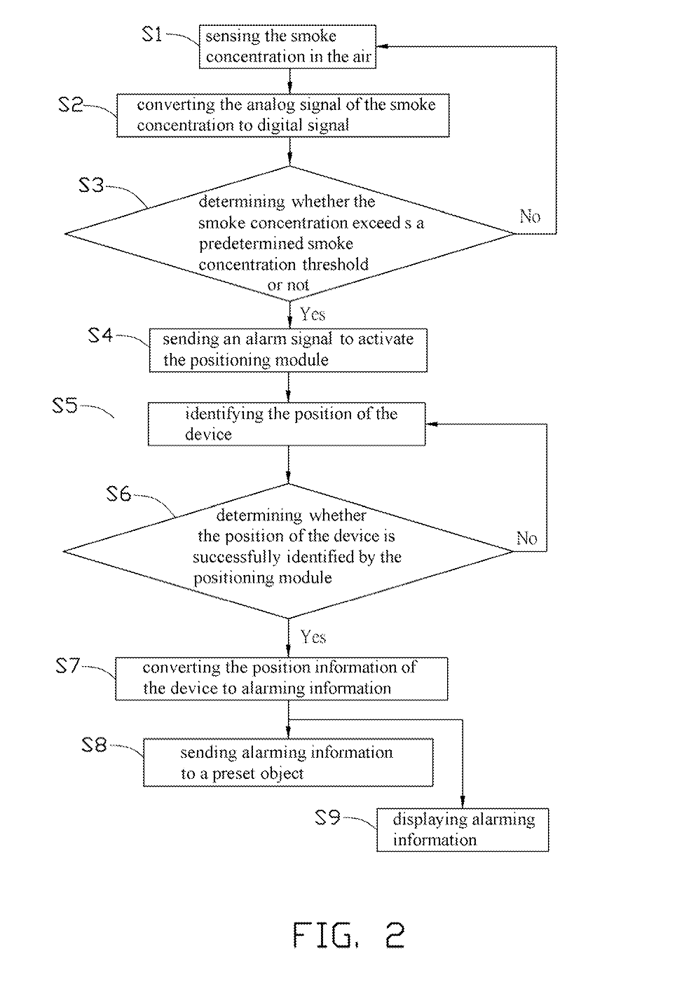

Referring to FIG. 2, the process of alarming method of the multifunctional portable electronic device 100 may include following steps:

In step S1, the smoke sensor 22 senses the smoke concentration of the environment, and sends the smoke concentration value to the A/D convertor 24.

In step S2, the A/D convertor 24 converts the analog signal of the smoke concentration value received from the smoke sensor 22 to digital signal, and sends the digital signal of the smoke concentration value to the data processing unit 31.

In step S3, the data processing unit 31 determines whether the received smoke concentration value exceeds a preset smoke concentration threshold preset therein, if no, the process returns back to step S1, if yes, the process goes to step S4.

In step S4, the data processing unit 31 sends a smoke level to the controlling unit 33, the controlling unit 33 sends an alarm signal to the positioning unit 42 to activate the positioning unit 42.

In step S5, the positioning unit 42 identifies the position of the portable electronic device 100 after receiving the alarm signal from the controlling unit 33.

In step S6, the judging unit 44 determines whether the positioning unit 42 successfully positions the portable electronic device 100, if no, the process returns back to step S5, if yes, the process goes to step S7.

In step S7, the judging unit 44 controls the positioning unit 42 to send the position information to the information managing unit 53, the information managing unit 53 converts the position information received from the positioning module 40 to alarming information such as a message.

In step S8, the wireless transmitting/receiving module 60 transmits the alarming information from the information managing unit 53 to a preset object such as a local emergency telephone number in the storage unit 51.

In step S9, the information managing unit 53 sends the alarming information to the CPU 70, the CPU 70 converts the received alarming information for the displaying module 80, and the displaying module 80 displays the alarming information.

In other embodiment, the step S9 can be omitted in the process, and the alarming information will not be displayed by the display module 80.

The multifunctional portable electronic device 100 having an integrated smoke alarm feature is convenient for users to carry. What more, the multifunctional portable electronic device 100 can monitors the smoke concentration in air, and intelligently sends a notice to a predetermined sending object in time when the smoke concentration exceeds a preset smoke concentration threshold, thus the multifunctional portable electronic device 100 can efficiently reduce the damage caused by a fire.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A multifunctional portable electronic device, comprising:
a power module;
a smoke sensing device;
a controlling module;
a positioning module;
an alarm module; and
a wireless transmitting/receiving module; wherein the power module, the smoke sensing device, the controlling module, the positioning module, the alarm module, and the wireless transmitting/receiving module are electrically connected together, the smoke sensing device senses the smoke concentration in the air, the controlling module determines whether the smoke concentration exceeds a preset smoke concentration threshold; and when the smoke concentration exceeds a preset smoke concentration threshold, the controlling module controls the positioning module to identify the position of the portable electronic device, the alarm module converts the position information to alarming information, and the alarming information is sent to a preset object via the wireless transmitting/receiving module.

2. The multifunctional portable electronic device as claimed in claim 1, further comprising a CPU and a displaying module, the alarm module is connected to the displaying module via the CPU, the CPU processes the alarming information from the alarm module, and the displaying module displays the processed alarming information.

3. The multifunctional portable electronic device as claimed in claim 2, wherein the smoke sensing device includes a smoke sensor and an A/D convertor, the smoke sensor senses the smoke concentration value in the air, the A/D convertor converts the analog signal of the smoke concentration sensed by the smoke sensor to a digital signal.

4. The multifunctional portable electronic device as claimed in claim 3, wherein the controlling module includes a data processing unit, and a controlling unit, the data processing unit has predetermined smoke concentration threshold therein, and determines whether the smoke concentration value received from the A/D convertor exceeds the predetermined smoke concentration threshold, the controlling unit controls the positioning module according to the smoke concentration value received from the A/D convertor.

5. The multifunctional portable electronic device as claimed in claim 4, wherein the positioning module includes a positioning unit and a judging unit, the positioning unit positioning the smoke when it receives a alarm signal from the controlling unit, the judging unit determines whether the positioning unit successfully positions the smoke, and sends position information to the alarm module.

6. The multifunctional portable electronic device as claimed in claim 5, wherein the alarm module includes a information managing unit and a storage unit, the information managing unit converts the position information received from the positioning unit to alarming information, the storage unit has predetermined an object to send the alarming information.

7. The multifunctional portable electronic device as claimed in claim 6, wherein the information managing unit is connected to the displaying module via the CPU to send the alarming information to the displaying module via the CPU.

8. The multifunctional portable electronic device as claimed in claim 1, wherein the positioning module is a module in a global position system (GPS).

9. A smoke sensing and alarming method, comprising:
sensing the smoke concentration in the air;
determining whether the smoke concentration exceeds a predetermined smoke concentration threshold;
identifying the position of the smoke when the smoke concentration exceeds the predetermined smoke concentration threshold;
converting the position information of the smoke to alarming information;
sending the alarming information to a predetermined object.

10. The smoke sensing and alarming method as claimed in claim 9, further comprising converting the analog signal of the smoke concentration to digital signal after sensing the smoke concentration in the air.

11. The smoke sensing and alarming method as claimed in claim 9, further comprising displaying the alarming information after converting the position information of the smoke to alarming information.

12. The smoke sensing and alarming method as claimed in claim 9, further comprising determining whether the identifying the position of the smoke is successful, and converting the position information of the smoke to alarming information when the identifying the position of the smoke is successful, returning back to position the smoke when the identifying the smoke is failing.

13. The smoke sensing and alarming method as claimed in claim 9, wherein the predetermined object is a local emergency telephone number.

14. The smoke sensing and alarming method as claimed in claim 9, wherein the alarming information is a message.
